(19) United States
(12) Patent Application Publication
(10) Pub. No.: US 2016/0356073 A1
(43) Pub. Date: Dec. 8, 2016

(54) Guide Device for a Sliding Door

(71) Applicant: Door & Window Hardware Co., Taichung City (TW)

(72) Inventors: Wei-Hung Chang, Taichung City (TW); Sung-Hui Lin, Taichung City (TW)

(21) Appl. No.: 14/730,422

(22) Filed: Jun. 4, 2015

(51) Int. Cl. E06B 3/46; E06B 3/54

(52) U.S. Cl. CPC E06B 3/4636; E06B 3/5454

(57) ABSTRACT

A guide device for a sliding door includes a base seat and a pair of side wall units. The base seat is formed with at least one guide groove. Each of the side wall units includes a rigid sidewall piece coupled to the base seat, movable relative to the base seat, and has at least one guide leg that engages slidably with the at least one guide groove. The rigid sidewall pieces of the side wall units define a gap therebetween. Each of the side wall units further includes a positioning element mounted to one of the rigid sidewall piece and the base seat and abutting releasably against the other one of the rigid sidewall piece and the base seat for locking the rigid sidewall piece to the base seat and fixing a width of the gap.

### FIELD

The disclosure relates to a guide device, more particularly to a guide device for a sliding door.

### BACKGROUND

A conventional integral type of guide block for guiding motion of a glass sliding door is generally formed with a guide groove having a fixed gap width, and is thereby only adaptable for use on a glass sliding door with a specific thickness. Therefore, the conventional guide block has poor adaptability, further restricted by the fact that during assembly, the guide block is first fastened to a floor before the glass sliding door is placed therebetween.

To resolve the aforementioned issue associated with the conventional integral guide block, referring to FIG. 1, a conventional guide device for a sliding door is disclosed in Chinese Patent Number CN102086729A. The conventional guide device includes a support member 1 formed with a pair of latch holes 101, a carrier member 2 mounted on the support member 1, a pair of sliding elements 3 mounted on the carrier member 2 and made of elastically deformable plastic, a pair of first screws 4 (only one is illustrated) and a pair of second screws 5.

The carrier member 2 includes a base board 201 and a pair of branch legs 202 connected integrally to the base board 201. The carrier member 2 is formed with a dovetail groove 203 in the base board 201 for the support member 1 to be slid in, a pair of first screw holes 204 (only one is visible), each of which is formed in a bottom end of a respective one of the branch legs 202 and is in spatial communication with the dovetail groove 203, a pair of a dented grooves 205 (only one is visible), each of which is formed at an inner side of a respective one of the branch legs 202, and a pair of a second screw holes 206, each of which is formed at a side of a respective one of the branch legs 202 and is in spatial communication with a corresponding one of the dented grooves 205.

Each of the sliding elements 3 is mounted on a respective one of the dented grooves 205, and includes a pair of loading portions 301 and a board portion 302 connected between the loading portions 301.

When assembling the conventional guide device, the support member 1 is first fixed to a floor. Next, the carrier member 2 mounted with the sliding elements 3 is slid to engage the dovetail groove 203 with the support member 1, and the first screws 4 are threaded respectively into the first screw holes 204 and embedded respectively in the latch holes 101 so as to fix the carrier member 2 to the support member 1 thereby. Lastly, the second screws 5 are threaded respectively into the second screw holes 206, abutting against and pushing the loading portions 301 of the sliding elements 3 as to result in elastic deformation of the board portions 302 of the sliding elements 3 to protrude inward so as to form a gap having a width corresponding to the thickness of the glass sliding door. Though this conventional guide device utilizes abutment and pushing of the second screws 5 for flexible adjustment of the gap between the board portions 302 of the sliding elements 3 for incorporation with glass sliding doors of different thicknesses, in practice, some disadvantages are still present in this conventional design, as set forth below:

1) The sliding elements 3 are made of elastically deformable plastic, and are subject to the flaw of elastic fatigue after bearing the stress caused by the second screws 5 for a long period of time;

2) Repeated friction between the board portions 302 of the sliding elements 3 and the glass sliding door is prone to eventually result in damage to the board portions 302;

3) To complete the assembly, the first screws 4 and the second screws 5 have to be fastened respectively. Wherein, the first screws 4 only function to fix the carrier member 2 to the support member 1, whereas the second screws 5 only function to bring about elastic deformation of the sliding elements 3. In view of the foregoing, the overall composition of the conventional guide device is relatively complicated and inconvenient for assembly; and 4) When facing the glass sliding door, one of the first screw holes 204 of the carrier member 2 is easily visible to a user, as is the respective first screw 4, hence taking away from the aesthetic quality of the conventional guide device.

### SUMMARY

A guide device for a sliding door includes a base seat and a pair of side wall units. The base seat extends in a longitudinal direction and is formed with at least one guide groove that extends in a transverse direction transverse to the longitudinal direction. Each of the side wall units includes a rigid sidewall piece coupled to the base seat, movable relative to the base seat in the transverse direction, and having at least one guide leg that engages slidably with the at least one guide groove. The rigid sidewall pieces of the side wall units define a gap therebetween. Each of the side wall units further includes a positioning element that is mounted to one of the rigid sidewall piece and the base seat and that abuts releasably against the other one of the rigid sidewall piece and the base seat for locking the rigid sidewall piece to the base seat and fixing a width of the gap in the transverse direction.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of a conventional guide device for a sliding door;

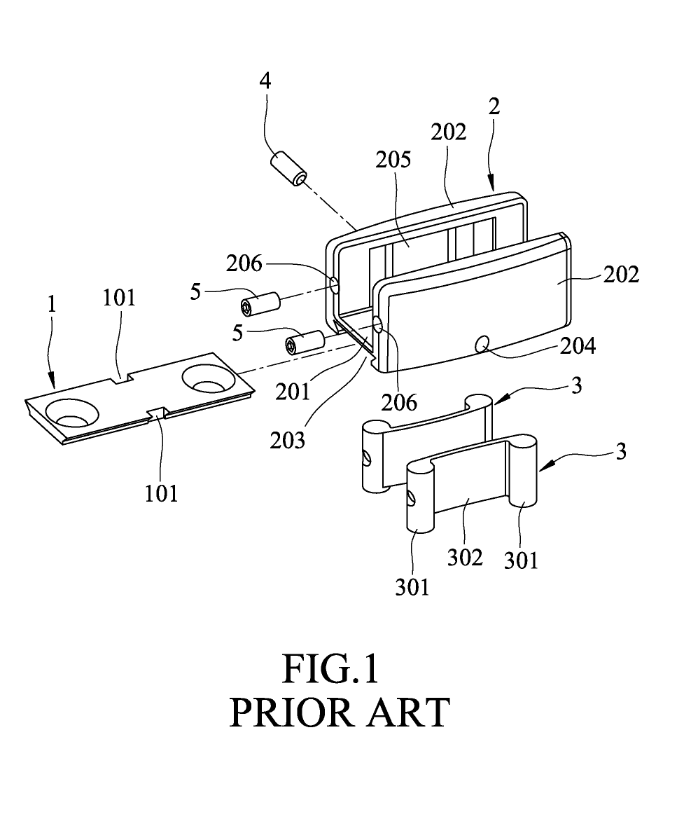

FIG. 2 is an assembled perspective view of the embodiment of a guide device for a sliding door according to the present disclosure;

FIG. 3 is an exploded perspective view of the embodiment;

FIG. 4 is a sectional view of the embodiment taken along line IV-IV in FIG. 2; and

FIG. 5 is a sectional view of the embodiment taken along line V-V in FIG. 4.

### DETAILED DESCRIPTION

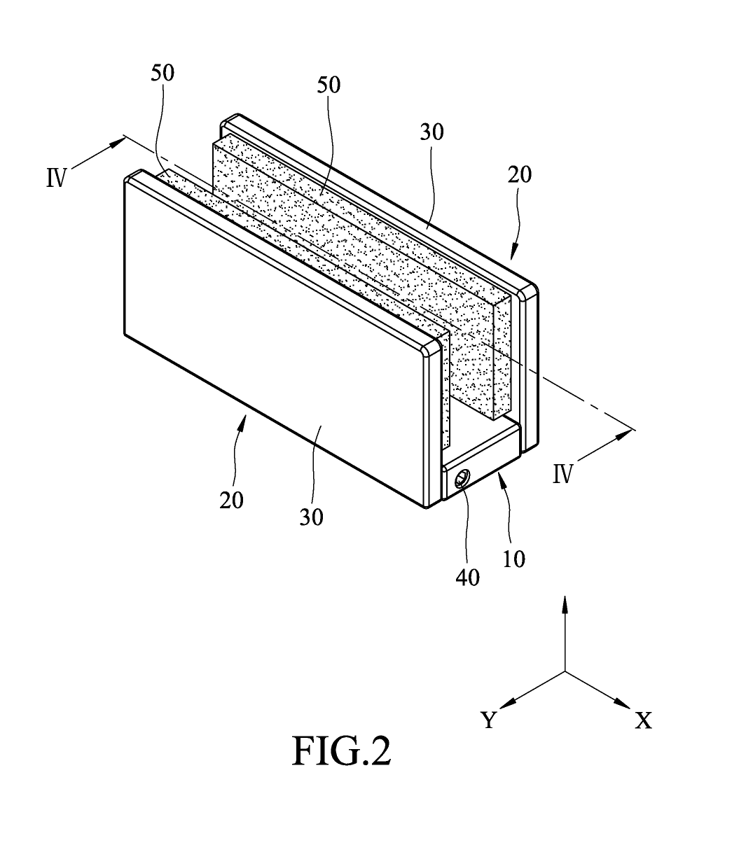

Referring to FIGS. 2, 3 and 4, the embodiment of a guide device for a sliding door according to the present invention is shown to include a base seat 10 and a pair of side wall units 20.

The base seat 10 extends in a longitudinal direction (X), and includes a pair of end faces 11 normal to the longitudinal direction (X) and spaced apart from each other in the longitudinal direction (X), a pair of side faces 12 normal to a transverse direction (Y) that is transverse to the longitudinal direction (X) and spaced apart from each other in the transverse direction (Y) as to be connected to the end faces 11, and a top face 13 and an opposite bottom face 14 connecting the end faces 11 and the side faces 12. Moreover, the base seat 10 is formed with a pair of end guide grooves 15 that extend in the transverse direction (Y) and that are spaced apart from each other in the longitudinal direction (X), a central guide groove 16 that extends in the transverse direction (Y) and that is disposed between the end guide grooves 15, and a pair of fixation holes 17 that extend through the top face 13 and the bottom face 14. One of the fixation holes 17 is disposed between the central guide groove 16 and one of the end guide grooves 15, and the other one of said fixation holes 17 is disposed between the central guide groove 16 and the other one of the end guide grooves 15.

In this embodiment, the end guide grooves 15 are disposed proximate to the end faces 11, respectively, at a bottom end of the base seat 10, and extend through the side faces 12 in the transverse direction (Y) and through the bottom side 14. Specifically, in this embodiment, each of the end guide grooves 15 and the central guide groove 16 is perpendicular to the side faces 12 of the base seat 10. Each of the end faces 11 is formed with a threaded hole 111 that is in spatial communication with a proximate one of the end guide grooves 15. Each of the end guide grooves 15 has a first abutting portion 151 tapering toward the central guide groove 16.

In this embodiment, the central guide groove 16 extends through the side faces 12 and the bottom face 14. The central guide groove 16 has a pair of second abutting portions 161, each of which tapers towards a respective one of the end guide grooves 15.

Each of the side wall units 20 includes a rigid sidewall piece 30 that is coupled to the base seat 10 and that is movable relative to the base seat 10 in the transverse direction (Y) in a stepless manner.

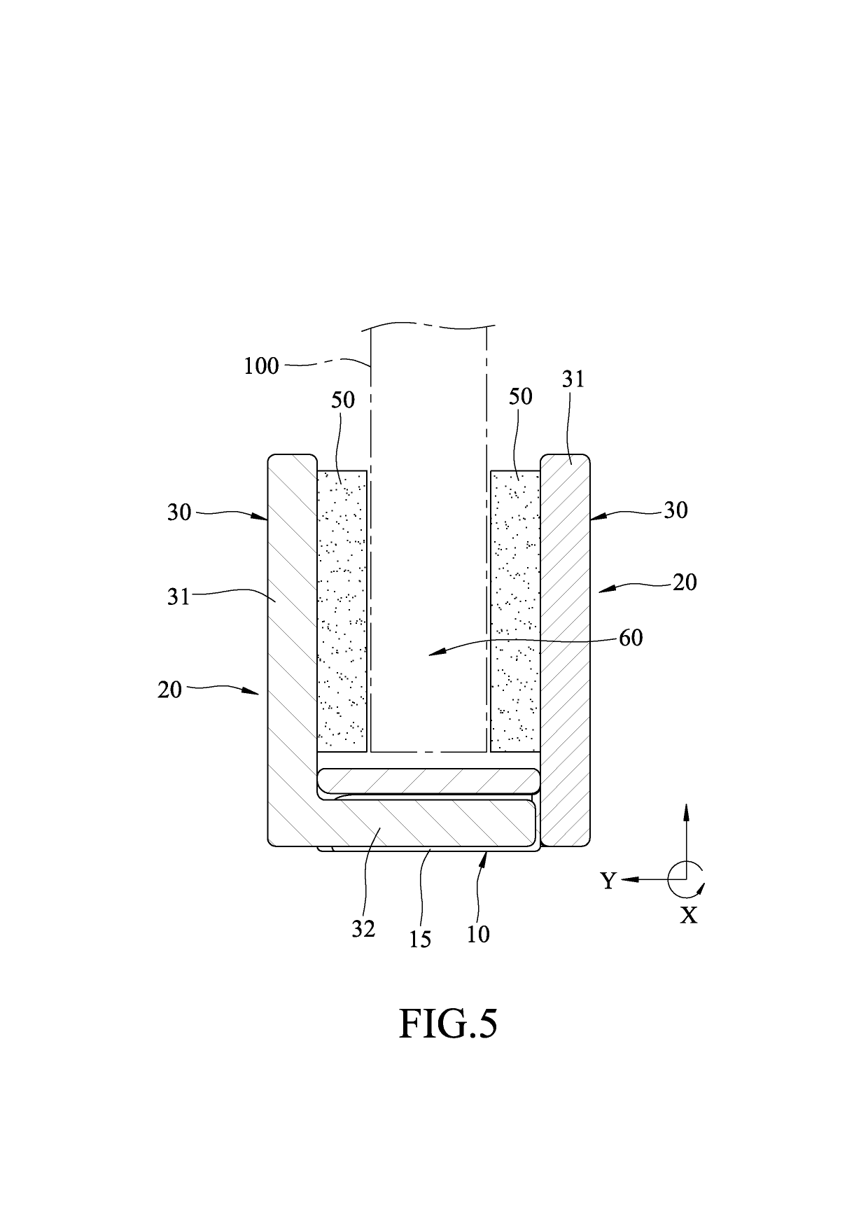

The rigid sidewall piece 30 of each of the side wall units 20 includes a side wall 31 and a pair of guide legs 32, 33 connected to a bottom end of the side wall 31. Specifically, in this embodiment, the guide legs 32, 33 of the sidewall piece 30 of each of the side wall units 20 is perpendicular to the bottom end of the side wall 31 of a corresponding one of the side wall units 20. The guide legs 33, 32 of the rigid sidewall pieces 30 of one of the side wall units 20 respectively have tapered fitting portions 331, 321 that engage fittingly, slidably and respectively one of the second abutting portions 161 of the central guide groove 16 and the first abutting portion 151 of one of the end guide grooves 15. The guide legs 33, 32 of the rigid sidewall piece 30 of the other one of the side wall units 20 also respectively have tapered fitting portions 331, 321 that engage fittingly, slidably and respectively the other one of the second abutting portions 161 of the central guide groove 16 and the first abutting portion 151 of the other one of the end guide grooves 15. The side walls 31 of the rigid sidewall pieces 30 of the rigid side wall units 20 cooperatively define a gap 60 (see FIG. 5) therebetween extending in the longitudinal direction (X).

In this embodiment, each of the side wall units 20 further includes a positioning element 40 mounted to the base seat 10 and abutting releasably against the guide leg 32 of the rigid sidewall piece 30 for locking the rigid sidewall piece 30 to the base seat 10 and fixing a width of the gap 60 in the transverse direction (Y). In this embodiment, the positioning element 40 of each of the side wall units 20 is a set screw threaded into the threaded hole 111 of a corresponding one of the end faces 11. The front end of the positioning element 40 is extended into a corresponding one of the end guide grooves 15 through the threaded hole 111 and abuts against the guide leg 32 in the corresponding one of the end guide grooves 15.

Each of the side wall units 20 further includes a slide guide element 50 mounted on an inner side of the side wall 31 of the rigid sidewall piece 30. In this embodiment, the slide guide element 50 is a felt slab and can be adhered to an inner side of the side wall by a double-sided adhesive tape. Moreover, in practice, the slide guide element 50 may also be made of plastic.

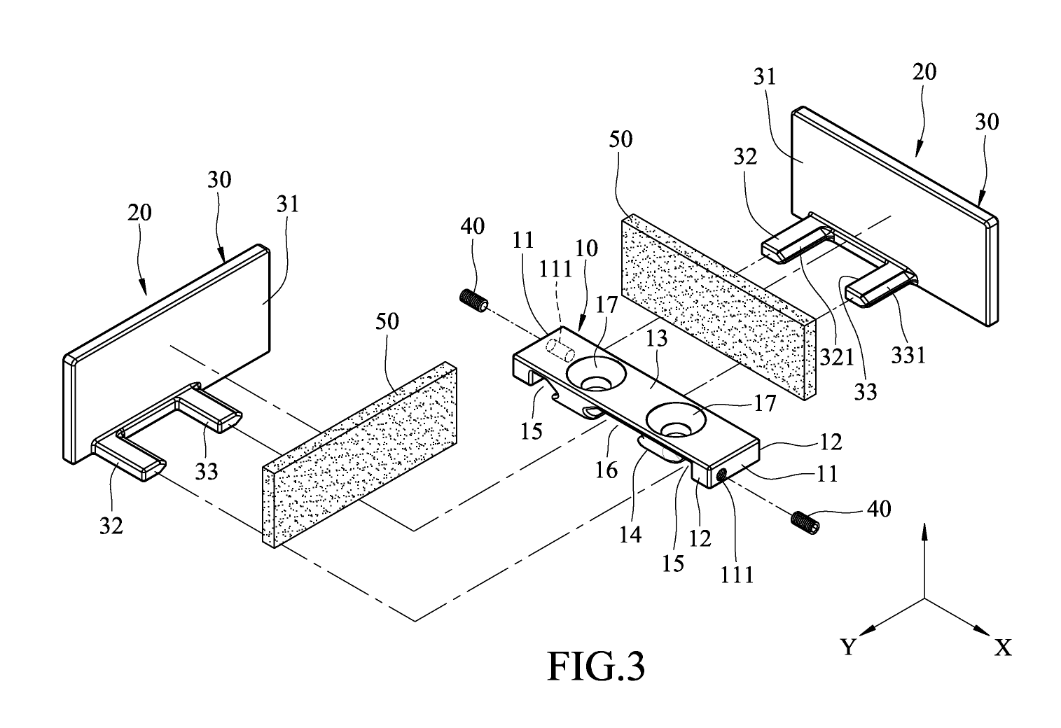

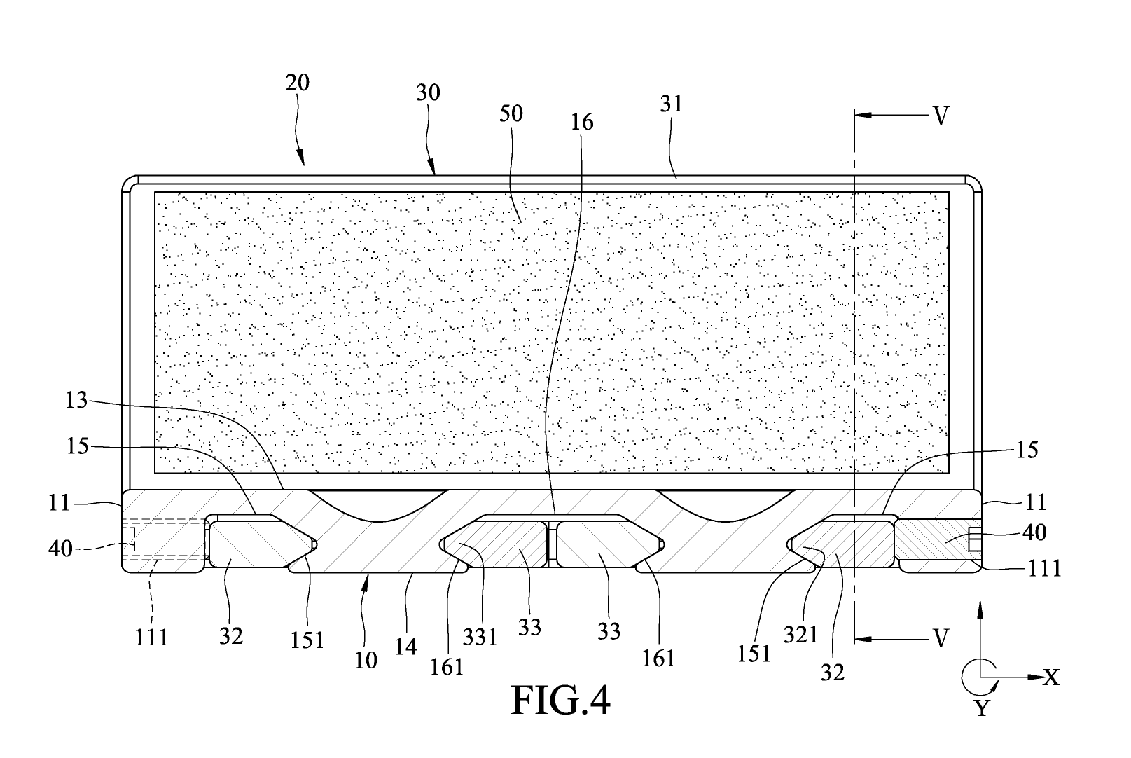

Therefore, as shown in FIGS. 4 and 5, for this embodiment to be incorporated with a glass sliding door 100 in the assembly process, a pair of fasteners (not shown) are first extended through the fixation holes 17 (as shown in FIG. 3) of the base seat 10 as to fasten fixedly the base seat 10 to a floor (not shown). Next, the mounting operation of the glass sliding door 100 is performed. Then, the guide legs 32, 33 of the rigid sidewall pieces 30 are slid into the end guide grooves 15 and the central guide groove 16 of the base seat 10, and based on the actual thickness of the glass sliding door 100, the rigid sidewall pieces 30 are moved steplessly in the transverse direction (Y) relative to the base seat 10 until the width of the gap 60 matches the thickness of the glass sliding door 100. Lastly, the positioning elements 40 are screwed tight to abut against the guide legs 32 of the rigid sidewall pieces 30 so as to position the rigid sidewall pieces 30 relative to the base seat 10. After completion of the assembly, this embodiment is usable for guiding the glass sliding door 100 to slide in the longitudinal direction (X).

From the foregoing, the guide device for a sliding door of the present disclosure may have the following advantages:

1) The rigid sidewall pieces 30 of the present invention are movable relative to the base seat 10 in the transverse direction (Y) in a stepless manner. When the width of the gap 60 is adjusted to match exactly the thickness of the glass sliding door 100, the function of the positioning elements 40 is only for abutment positioning of the guide legs 32 of the rigid sidewall pieces 30, preventing any deformation caused by stress of the side walls 31 of the rigid sidewall pieces 30. The rigid sidewall pieces 30 of the present disclosure may hence have a relatively long service life, without the concern of elastic fatigue, when compared with the conventional guide device.

2) The side walls 31 of the rigid sidewall pieces 30 of the present disclosure are free from contacting the glass sliding door 100, so that no friction is generated between the glass sliding door 100 and the side walls 31 as to cause damage to the side walls 31. Moreover, the slide guide elements 50 of the present disclosure are designed to be replaceable, so that when the slide guide elements 50 are worn out, they can be easily removed from the side walls 31 and replaced.

3) By simply loosening the positioning elements 40, the rigid sidewall pieces 30 are permitted to be moved in the transverse direction (Y) relative to the base seat 10, with the width of the gap 60 being simultaneously adjusted. When the adjustment of the positions of the rigid sidewall pieces 30 is complete, the rigid sidewall pieces 30 can be easily locked to the base seat 10 by refastening the positioning elements 40.

4) In this embodiment, only the end faces 11 of the base seat 10 are formed with the threaded holes 111 in the longitudinal direction (X). No holes are formed on the side walls 31 of the rigid sidewall pieces 30. As such, no screws or screw holes would be visible to a user facing the glass sliding door 100, thereby improving the aesthetic appearance of the guide device.

In sum, the present disclosure can be adapted for sliding doors of different thicknesses more easily, more enduringly, and more aesthetically than the conventional guide device, thereby achieving the object of this disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

1. A guide device for a sliding door, comprising:
a base seat extending in a first direction, and formed with at least one guide groove that extends in a second direction transverse to the first direction; and
a pair of side wall units, each of which includes
a rigid sidewall piece coupled to said base seat, movable relative to said base seat in the second direction, and having at least one guide leg that engages slidably with said at least one guide groove, said rigid sidewall pieces of said side wall units defining a gap therebetween, and
a positioning element mounted to one of said rigid sidewall piece and said base seat, and abutting releasably against the other one of said rigid sidewall piece and said base seat for locking said rigid sidewall piece to said base seat and fixing a width of said gap in the second direction;
wherein said at least one guide groove includes three guide grooves being respectively a pair of end guide grooves that extend in the second direction and that are spaced apart from each other in the first direction, and a central guide groove that extends in the second direction and that is disposed between said end guide grooves;
wherein said rigid sidewall piece of each of said side wall units includes a pair of guide legs, said guide legs of said rigid sidewall piece of one of said side wall units engaging slidably and respectively said central guide groove and one of said end guide grooves, said guide legs of said rigid sidewall piece of the other one of said side wall units engaging slidably and respectively said central guide groove and the other one of said end guide grooves;
wherein said positioning element of each of said side wall units is mounted to said base seat and abuts releasably against one of said guide legs; and
wherein said base seat has a pair of end faces spaced apart from each other in the first direction, and a pair of side faces connected to said end faces and spaced apart from each other in the second direction, said end guide grooves extending through said side faces and respectively being disposed proximate to said end faces, said central guide groove extending through said side faces, each of said end faces being formed with a threaded hole that is in spatial communication with the respective one of said end guide grooves, said positioning element of each of said side wall units extending threadedly into said threaded hole of a corresponding one of said end faces.

2-3. (canceled)

4. The guide device for a sliding door as claimed in claim 1, wherein:
each of said end guide grooves has a first abutting portion tapering toward said central guide groove;
said central guide groove has a pair of second abutting portions, each of which tapers toward a respective one of said end guide grooves; and
said guide legs of said rigid sidewall piece of said one of said side wall units respectively have tapered fitting portions that engage fittingly, slidably and respectively one of said second abutting portions of said central guide groove and said first abutting portion of one of said end guide grooves, said guide legs of said rigid sidewall piece of said other one of said side wall units respectively having tapered fitting portions that engage fittingly, slidably and respectively the other one of said second abutting portions of said central guide groove and said first abutting portion of said other one of said end guide grooves.

5. The guide device for a sliding door as claimed in claim 2, wherein:
each of said end guide grooves and said central guide groove is disposed at a bottom end of said base seat, and extends through and is perpendicular to said side faces of said base seat; and
said rigid sidewall piece of each of said side wall units further includes a side wall, said guide legs of said sidewall piece of each of said side wall units being connected to and perpendicular to a bottom end of said side wall of a corresponding one of said side wall units.

6. The guide device for a sliding door as claimed in claim 2, wherein said base seat further has opposite top and bottom faces connecting said end faces and said side faces, said end guide grooves and said central guide groove extending through said bottom face.

7. The guide device for a sliding door as claimed in claim 4, wherein said base seat is further formed with a pair of fixation holes extending through said top face and said bottom face, one of said fixation holes being disposed between said central guide groove and one of said end guide grooves, the other one of said fixation holes being disposed between said central guide groove and the other one of said end guide grooves.

8. The guide device for a sliding door as claimed in claim 2, wherein each of said positioning elements is a set screw.

9. The guide device for a sliding door as claimed in claim 1, wherein:
said rigid sidewall piece of each of said side wall units further has a side wall connected to said at least one guide leg, said side walls of said side wall units defining said gap therebetween; and
each of said side wall units further includes a slide guide element being mounted on an inner side of said side wall.

10. The guide device for a sliding door as claimed in claim 1, wherein said rigid sidewall pieces of said side wall units are movable relative to said base seat in the second direction in a stepless manner.

11. The guide device for a sliding door as claimed in claim 1, wherein said gap extends in the first direction.
